(19) United States
(12) Patent Application Publication
(10) Pub. No.: US 2007/0008619 A1
(43) Pub. Date: Jan. 11, 2007

(54) 2D/3D switchable stereoscopic display providing image with complete parallax

(75) Inventors: Kyung-hoon Cha, Yongin-si (KR); Sergey Shestak, Suwon-si (KR); Dae-sik Kim, Suwon-si (KR); Sung-yong Jung, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/482,025

(22) Filed: Jul. 7, 2006

(30) Foreign Application Priority Data
Jul. 7, 2005 (KR) 10-2005-0061182

(51) Int. Cl. G02B 27/22

(52) U.S. Cl. 359/462

(57) ABSTRACT

A 2D/3D switchable stereoscopic display which can provide a 3D image with complete parallax using two polarization grating screens is provided. The 2D/3D switchable stereoscopic display includes a display device which an image and a parallax barrier unit including first and second polarization grating screens facing each other. The parallax barrier unit has a 2D mode and a 3D mode and is switched between the 2D mode and the 3D mode when the two polarization grating screens are moved relative to each other. In the 2D mode, the parallax barrier unit transmits all light, and in the 3D mode, it forms a barrier and a plurality of apertures which are arranged at predetermined intervals in two dimensions, thereby transmitting light through only the apertures and thus providing a 3D image with horizontal parallax and vertical parallax.

### CROSS-REFERENCE TO RELATED PATENT APPLICATION

This application claims priority from Korean Patent Application No. 10-2005-0061182, filed on Jul. 7, 2005, in the Korean Intellectual Property Office, the disclosure of which is incorporated herein in its entirety by reference.

### BACKGROUND OF THE INVENTION

1. Field of the Invention

Apparatuses and methods consistent with the present invention relate to a stereoscopic display which switches between a 2D mode and a 3D mode and provides a 3D image with complete parallax.

2. Description of the Related Art

Generally, three dimensional (3D) images are made based on the principle of stereo image sensing by two eyes. Binocular parallax resulting from the eyes being separated by about 65 mm is the most important factor for producing a 3D effect. Recently, the demand for stereoscopic displays that provide a stereoscopic image using binocular parallax has greatly increased in various fields, such as medical applications, games, advertising, education applications, and military training. With the development of high resolution televisions, stereo televisions providing stereoscopic images are expected to be widely used in the future.

Stereoscopic displays may use displays which require glasses or glassesless displays. In general, as shown in FIG. 1, a stereoscopic display requiring glasses includes a liquid crystal display (LCD) which displays an image with a predetermined polarization component, a micro polarizing screen 110 which changes the polarization direction of an image for a left eye and an image for a right eye produced by the LCD 100, and polarization glasses 120 which transmit images with different polarization states to the left eye and right eye. For example, the micro polarizing screen 110 includes a combination of alternately disposed 0° retarders 110a and 90° retarders 110b. Also, the polarization glasses 120 include a pair of polarization plates 120a and 120b through which light with different polarization states is transmitted. Since the micro polarizing screen 110 makes the polarizations of the left-eye image and the right-eye image different from each other and the polarization glasses 120a and 120b respectively transmit the left-eye image and the right-eye image, a viewer can see a 3D image.

However, the stereoscopic display has a disadvantage in that the viewer must wear the polarization glasses 120 to see the 3D image. To solve this problem, a glassesless stereoscopic display has been developed. A glassesless stereoscopic display produces a 3D image by separating an image for a left eye from an image for a right eye without the use of glasses. In general, glassesless stereoscopic displays are divided into parallax barrier displays and lenticular displays. In a parallax barrier display, images to be seen by left and right eyes are alternately displayed using vertical stripes produced by a very thin vertical lattice, that is, a barrier. In this way, a vertical pattern image to be seen by the left eye and a vertical pattern image to be seen by the right eye are separated by the barrier and the left and right eyes see images at different viewpoints so as to see a 3D image.

In the parallax barrier display, as shown in FIG. 2, a parallax barrier 50 having apertures 55 and masks 57 formed in a vertical grating pattern is disposed in front of an LCD panel 53 that has left-eye image pixels L and right-eye image pixels R respectively corresponding to a viewer's left eye LE and right eye RE, such that each eye sees a different image through the apertures 55 of the parallax barrier 50. The left-eye image pixels L to be input to the left eye LE and the right-eye image pixels R to be input to the right eye RE are alternately formed in a horizontal direction in the LCD panel 53. In this structure, the left-eye image L is separated by the parallax barrier 50 to be input to the left eye LE of the viewer, and the right-eye image R is separated by the parallax barrier 50 to be input to the right eye RE of the viewer. Accordingly, the viewer can see a 3D image without glasses.

However, this method has a disadvantage in that, since a viewing zone in which a 3D image can be seen is narrow, slight movement by the viewer causes an inversion of the 3D image or the disappearance of the 3D image itself. FIGS. 3A and 3B illustrate a parallax barrier 60 having a wider viewing zone in which a 3D image can be seen. Referring to FIG. 3A, pairs of right-eye image pixels R and left-eye image pixels L are alternately arranged in an LCD panel 53, and apertures 65 formed in a vertical grating pattern are disposed between masks 67 such that an aperture 65 is formed every other pixel. In this case, since the right-eye image pixels R and the left-eye image pixels L can be seen in wider areas, a viewing zone in which a 3D image can bee seen is wider than that when an aperture is formed for every pixel. Referring to FIG. 3B, groups of four right-eye image pixels R and four left-eye image pixels L are alternately displayed in the LCD panel 53, and apertures 75 formed in a vertical grating pattern are disposed between masks 77 such that an aperture 75 is formed for every four pixels. Accordingly, a viewing zone in which a 3D image can be seen is wider than that when each aperture is formed for every other pixel.

Since the above apertures are formed in the vertical grating patterns, the viewer can see a 3D image only when the viewer's eyes are disposed horizontally. If the viewer tilts his head to one side, the heights of the left eye and the right eye become different from each other, thereby making it impossible to watch a perfect 3D image. To solve this problem, a parallax barrier 80 illustrated in FIG. 3C provides an image with complete parallax. Referring to FIG. 3C, an LCD panel 53 may be formed such that right-eye image pixels R and left-eye image pixels L alternately displayed in 4×4 blocks of pixels. A parallax barrier 80 includes apertures 85 disposed between masks 87 such that an aperture 85 is formed for every block of sixteen pixels. Each of the apertures 85 has a size equal to or slightly smaller than the size of one pixel. By doing so, even if the viewer lies on his side, he can see a 3D image.

Meanwhile, to display a 2D image or a 3D image according to an image signal received by a display device, the stereoscopic display must switch between a 2D mode and a 3D mode. To this end, a variety of switchable stereoscopic displays have been developed. For example, according to a 2D/3D switchable stereoscopic display disclosed in U.S. Patent Publication No. 2004-0109115, two micro retarders including a plurality of vertical stripes are relatively displaced to provide a 2D image or a 3D image. However, the conventional 2D/3D switchable stereoscopic display can provide only one of horizontal parallax and vertical parallax. Accordingly, the conventional 2D/3D switchable stereoscopic display cannot provide a 3D image with complete parallax by simultaneously providing both horizontal parallax and vertical parallax.

### SUMMARY OF THE INVENTION

Exemplary embodiments of the present invention provide a 2D/3D switchable stereoscopic display which can provide a 3D image with complete parallax by simultaneously providing both horizontal parallax and vertical parallax.

According to an exemplary aspect of the present invention, there is provided a 2D/3D switchable stereoscopic display comprising a display device which displays an image and a parallax barrier unit including first and second polarization grating screens facing each other. The parallax barrier unit has a 2D mode and a 3D mode and can be switched between the 2D mode and the 3D mode by moving one of the polarization grating screens with respect to the other. In the 2D mode, the parallax barrier unit transmits all light, and in the 3D mode, the parallax barrier unit forms a barrier and a plurality of apertures which are arranged at predetermined intervals in two dimensions, thereby transmitting light through only the apertures and thus providing a 3D image with horizontal parallax and vertical parallax, i.e., complete parallax.

The parallax barrier unit may also comprise a first polarization plate which transmits only light with a predetermined polarization direction and a second polarization plate, facing the first polarization plate, which transmits only light with a predetermined polarization direction. The first polarization grating screen may have groups of first through fourth lines formed in a repeating pattern. The first line includes first birefringence elements that change the polarization of incident light to a first direction and second birefringence elements that alternate with the first birefringence elements and change the polarization direction to a second direction. The second line includes only the first birefringence elements. The third line includes the second birefringence elements and the first birefringence element alternating with each other. The fourth line includes only the second birefringence elements. The second polarization grating screen may have groups of first through fourth lines formed in a repeating pattern. The first line includes third birefringence elements that change the polarization direction of incident light to the second direction and fourth birefringence elements that alternate with the third birefringence elements and change the polarization direction of incident light to the first direction. The second line includes only the third birefringence elements. The third line includes the fourth birefringence elements and the third birefringence elements alternating with each other. The fourth line includes only the fourth birefringence elements. The first and second polarization grating screens are disposed between the first and second polarization plates.

The display may further comprise a displacement means for moving at least one of the first polarization grating screen and the second polarization grating screen such that a 2D image or a 3D image is selectively displayed according to the relative positions of the first polarization grating screen and the second polarization grating screen.

The width of each of the first through fourth birefringence elements may be equal to the width of two pixels of the display device, and the sum of the heights of the first and second lines and the sum of the heights of the third and fourth lines of each of the first and second polarization grating screens may be each equal to the height of two pixels of the display device.

The width of each of the first through fourth birefringence elements may be equal to the width of four pixels of the display device, and each of the sum of the heights of the first and second lines of the first polarization grating screen and the sum of the heights of the third and fourth lines of the second polarization grating screen may be each equal to the height of four pixels of the display device.

The height of each of the first line and the third line of each of the first and second polarization grating screens may not be greater than the height of one pixel of the display device.

According to another exemplary aspect of the present invention the display may further include a displacement means for moving at least one of the first polarization grating screen and the second polarization grating screen in a diagonal direction to form a barrier which blocks light and has a plurality of apertures which are regularly arranged in two dimensions and transmit light.

A horizontal displacement of the first polarization grating screen relative to the second polarization grating screen may not be greater than the width of one pixel of the display device, and the first polarization grating screen and the second polarization grating screen may be vertically displaced such that the third line of the first polarization grating screen and the first line of the second polarization grating screen overlap each other.

The third line of the first polarization grating screen may be shifted horizontally from the first line of the first polarization grating screen by a maximum distance corresponding to the width of one pixel of the display device, and the third line of the second polarization grating screen may be shifted horizontally from the first line of the second polarization grating screen by a maximum distance corresponding to the width of one pixel of the display device.

According to another exemplary aspect of the present invention, the display may further include a displacement means for vertically displacing at least one of the first polarization grating screen and the second polarization grating screen to form a barrier which blocks light and a plurality of apertures which are regularly arranged in two dimensions and transmit light.

The first polarization grating screen and the second polarization grating screen may be vertically displaced such that the third line of the first polarization grating screen and the first line of the second polarization grating screen overlap each other.

The first and fourth birefringence elements may be rotators which rotate incident light by +45° and the second and third birefringence elements may be rotators which rotate incident light by −45°, or the first and fourth birefringence elements may be rotators which rotate incident light by −45° and the second and third birefringence elements may be rotators which rotate incident light by +45°.

The first and third birefringence elements may be rotators which rotate incident light by +45° and the second and fourth birefringence elements may be rotators which rotate incident light by −45°, or the first and third birefringence elements may be rotators which rotate incident light by −45° and the second and fourth birefringence elements may be rotators which rotate incident light by +45°.

The first and fourth birefringence elements may be retarders which phase-delay incident light by +λ/4 and the second and third birefringence elements may be retarders which phase-delay incident light by −λ/4, or the first and fourth birefringence elements may be retarders which phase-delay incident light by −λ/4 and the second and third birefringence elements may be retarders which phase-delay incident light by +λ/4.

The first and third birefringence elements may be retarders which phase-delay incident light by +λ/4 and the second and fourth birefringence elements may be retarders which phase-delay incident light by −λ/4, or the first and third birefringence elements may be retarders which phase-delay incident light by −λ/4 and the second and fourth birefringence elements may be retarders which phase-delay incident light by +λ/4.

The display device may include a plurality of pixels which are arranged in two dimensions and each of which emits light independently, and the parallax barrier unit may be disposed between the display device and a viewer.

According to another exemplary aspect of the present invention, a display device may comprise: a backlight unit which emits light; a rear polarization plate which transmits only light having a predetermined polarization direction; a liquid crystal display panel which polarizes incident light for each pixel and provides an image; and a front polarization plate which transmits only light having a predetermined polarization direction. The parallax barrier unit is disposed between the liquid crystal display panel and a viewer. The front polarization plate of the display device is the first polarization plate of the parallax barrier unit.

According to another exemplary aspect of the present invention, a display device may comprise: a backlight unit which emits light; a rear polarization plate which transmits only light having a predetermined polarization direction; a liquid crystal display panel which polarizes incident light for each pixel and provides an image; and a front polarization plate which transmits only light having a predetermined polarization direction. The parallax barrier unit is disposed between the backlight unit and the liquid crystal display panel. The rear polarization plate of the display device is the second polarization plate of the parallax barrier unit.

### BRIEF DESCRIPTION OF THE DRAWINGS

The above and other exemplary aspects of the present invention will become more apparent from the following detailed description of exemplary embodiments thereof with reference to the attached drawings in which:

FIG. 1 illustrates a conventional stereoscopic display using glasses;

FIG. 2 is a schematic view for explaining the principle of a conventional parallax barrier stereoscopic display;

FIGS. 3A through 3C are schematic views for explaining the principle of conventional parallax barrier stereoscopic displays that provide images with complete parallax;

FIGS. 4A and 4B illustrate polarization grating screens of a 2D/3D switchable stereoscopic display according to an exemplary embodiment of the present invention;

FIGS. 5A through 5D are schematic views for explaining a method of forming a two dimensional (2D) image using the polarization grating screens of FIGS. 4A and 4B according to an exemplary embodiment of the present invention;

FIGS. 6A through 6D are schematic views for explaining a method of forming a three dimensional (3D) image with complete parallax using the polarization grating screens of FIGS. 4A and 4B according to an exemplary embodiment of the present invention;

FIGS. 7A and 7B illustrate polarization grating screens of a 2D/3D switchable stereoscopic display according to another exemplary embodiment of the present invention;

FIG. 8A is a schematic view for explaining a method of forming a 2D image using the polarization grating screens of FIGS. 7A and 7B;

FIG. 8B is a schematic view for explaining a method of forming a 3D image using the polarization grating screens of FIGS. 7A and 7B;

FIGS. 9A and 9B illustrate polarization grating screens of a 2D/3D switchable stereoscopic display according to still another exemplary embodiment of the present invention;

FIG. 10A is a schematic view for explaining a method of forming a 2D image using the polarization grating screens of FIGS. 9A and 9B; and

FIG. 10B is a schematic view for explaining a method of forming a 3D image using the polarization grating screens of FIGS. 9A and 9B.

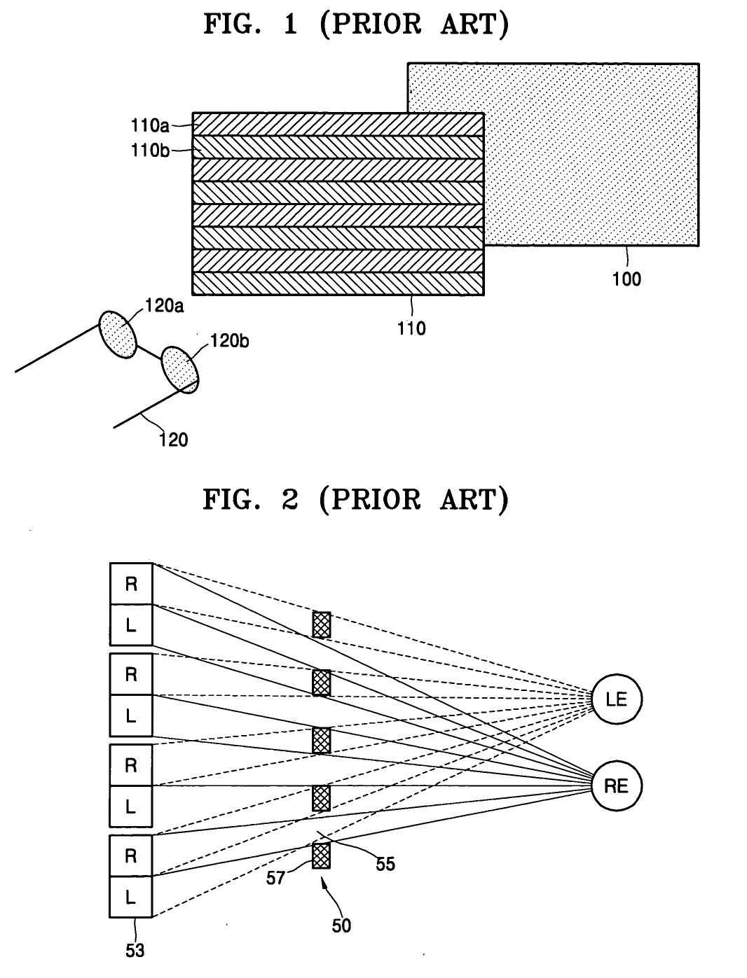

### DETAILED DESCRIPTION OF EXEMPLARY EMBODIMENTS OF THE INVENTION

The present invention will now be described more fully with reference to the accompanying drawings, in which exemplary embodiments of the invention are shown.

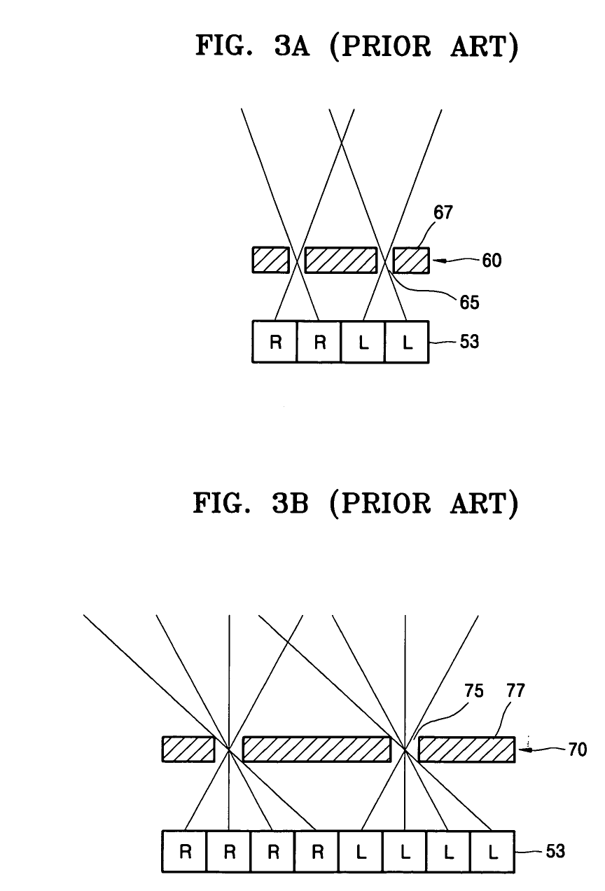

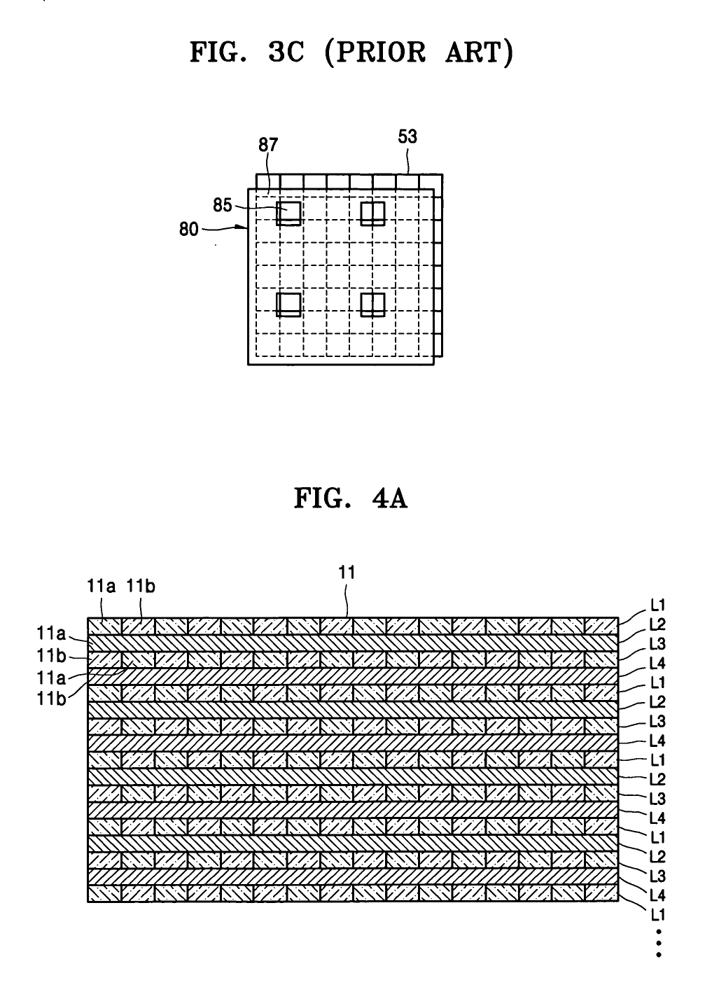

A stereoscopic display according to an exemplary embodiment of the present invention selectively displays a two dimensional (2D) image or a three dimensional (3D) image with complete parallax according to the positions of two facing polarization grating screens by moving the two polarization grating screens relative to each other. That is, the stereoscopic display transmits light through the entire area of the polarization grating screens in a 2D mode, whereas it forms a barrier and a plurality of apertures, which are arranged in two dimensions as shown in FIG. 3C, in a 3D mode, thereby transmitting light through only the apertures in a 3D mode and thus providing a 3D image with both horizontal parallax and vertical parallax, i.e., complete parallax. To this end, the polarization grating screens include birefringence elements, which are rotators or retarders, which change the polarization of transmitted light.

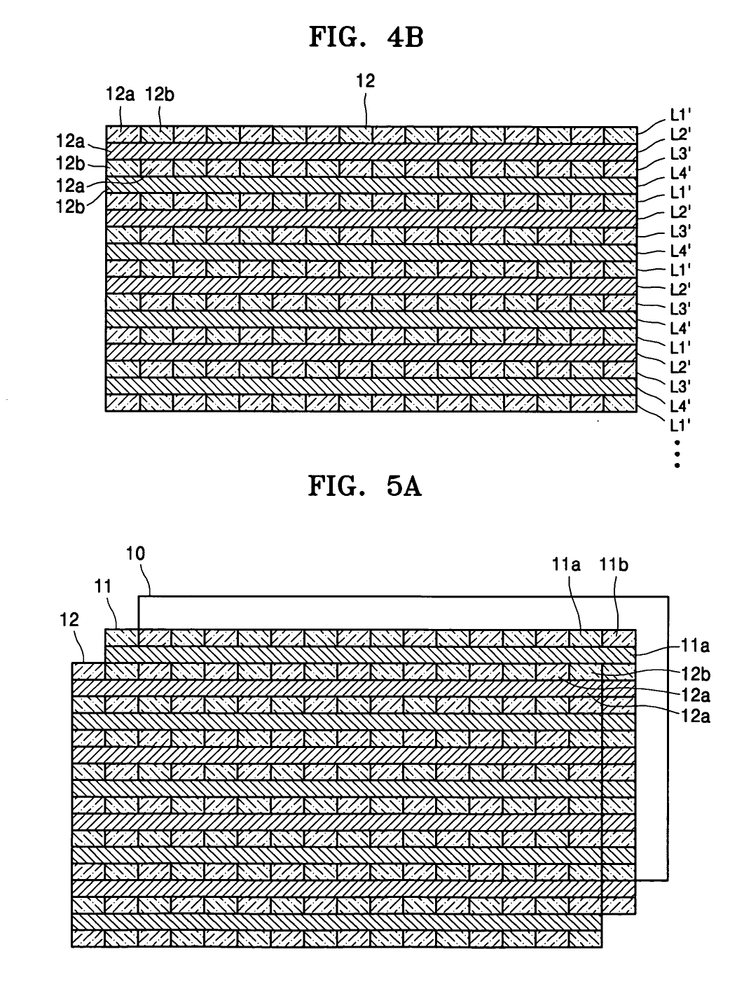

FIGS. 4A and 4B illustrate first and second polarization grating screens 11 and 12 of a 2D/3D switchable stereoscopic display according to an embodiment of the present invention. Referring to FIG. 4A, the first polarization grating screen 11 includes first through fourth lines L1 through L4 which are formed in a repeating pattern. The first line L1 includes first birefringence elements 11a that change the polarization direction of incident light to one direction and second birefringence elements 11b that alternate with the first birefringence elements 11a and change the polarization direction of incident light to another direction. The second line L2 includes only the first birefringence elements 11a. The third line L3 includes the second birefringence elements 11b and the first birefringence elements 11a alternating with each other. The fourth line L4 includes only the second birefringence elements 11b. Referring to FIG. 4B, the second polarization grating screen 12 includes first through fourth lines L1′ through L4′ which are formed in a repeating pattern. The first line L1′ includes third birefringence elements 12a that change the polarization direction of incident light to one direction and fourth birefringence elements 12b that alternate with the third birefringence elements 12a and change the polarization direction of incident light to another direction. The second line L2′ includes only the third birefringence elements 12a. The third line L3′ includes the fourth birefringence elements 12b and the third birefringence elements 12a alternating with each other. The fourth line L4′ includes only the fourth birefringence elements 12b.

In the first polarization grating screen 11, the width of the first and second birefringence elements 11a and 11b may be equal to the width of two pixels of a display device, such as a cathode ray tube (CRT), an LCD, or a plasma display panel (PDP). In this case, the sum of the heights of the first and second lines L1 and L2 of the first polarization grating screen 11 and the sum of the heights of the third and fourth lines L3 and L4 of the first polarization grating screen 11 are each equal to the height of two pixels of the display device. For example, each of the heights of the first and second lines L1 and L2 may be equal to the height of one pixel of the display device, or the height of the first line L1 may be less than the height of the second line L2. Likewise, each of the heights of the third and fourth lines L3 and L4 may be equal to the height of one pixel of the display device, or the height of the third line L3 may be less than the height of the fourth line L4. Also, the heights of the first line L1 and L3 may be equal to each other, and the heights of the second line L2 and the fourth line L4 may be equal to each other.

The pattern of the second polarization grating screen 12 can completely overlap the pattern of the first polarization grating screen 11. To this end, the widths of the birefringence elements 12a and 12b and the heights of the lines L1′ through L4′ can be equal to the corresponding heights of the birefringence elements 11a and 11b and the corresponding heights of the lines L1 through L4 of the first polarization grating screen 11. For example, the width of the third and fourth birefringence elements 12a and 12b may be equal to the width of two pixels of the display device. Also, each of the sum of the heights of the first and second lines L1′ and L2′ of the second polarization grating screen and the sum of the heights of the third and fourth lines L3′ and L4′ of the second polarization grating screen 12 may each be equal to the height of two pixels of the display device.

According to the present embodiment, the first through fourth birefringence elements 11a, 11b, 12a, and 12b may be rotators which are circular birefringence elements. For example, the first and fourth birefringence elements 11a and 12b may be rotators rotating incident light by +45° and the second and third birefringence elements 11b and 12a may be rotators rotating incident light by −45°. Alternatively, the first and fourth birefringence elements 11a and 12b may be rotators rotating incident light by −45° and the second and third birefringence elements 11b and 12a may be rotators rotating incident light by +45°.

According to another embodiment of the present invention, the first through fourth birefringence elements 11a, 11b, 12a, and 12b may be retarders which are linear birefringence elements. For example, the first and fourth birefringence elements 11a and 12b may be retarders phase-delaying incident light by +λ/4 and the second and third birefringence elements 11b and 12a may be retarders phase-delaying incident light by −λ/4. Alternatively, the first and fourth birefringence elements 11a and 12b may be retarders phase-delaying incident light by −λ/4 and the second and third birefringence elements may be 11b and 12a retarders phase-delaying incident light by +λ/4. Here, λ is the wavelength of incident light. In general, when incident polarized light is phase-delayed by +λ/4 or −λ/4, the polarization direction of the incident light is changed by +45° or −45°. Accordingly, irrespective of whether the first through fourth birefringence elements 11a, 11b, 12a, and 12b are rotators or retarders, they can uniquely change the polarization direction of incident light.

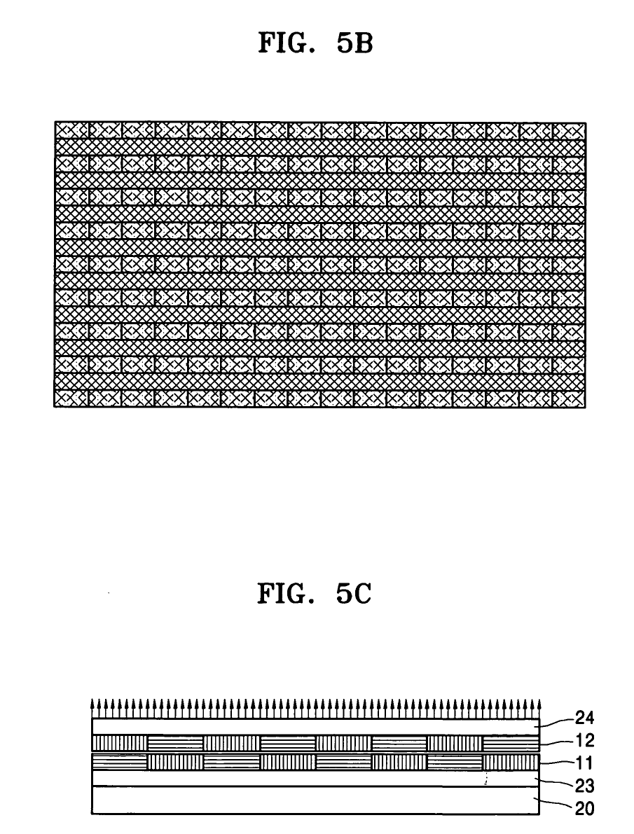

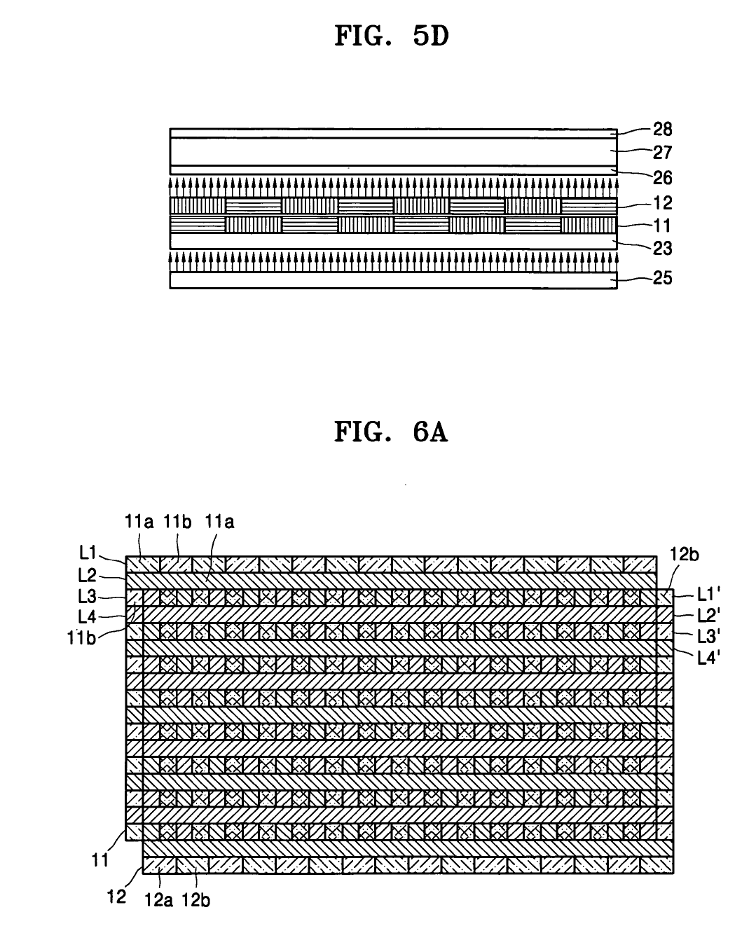

FIGS. 5A through 5D are schematic views for explaining a method of forming a 2D image using the first and second polarization grating screens 11 and 12 of FIGS. 4A and 4B according to an embodiment of the present invention.

Referring to FIG. 5A, the first and second polarization grating screens 11 and 12 may face each other in front of a display device 10. Referring to FIG. 5B, to produce a 2D image, the first and second polarization grating screens 11 and 12 overlap each other such that the first and second birefringence elements 11a and 11b of the first polarization grating screen 11 coincide with the corresponding third and fourth birefringence elements 12a and 12b of the second polarization grating screen 12. For example, as a result, light transmitted through the first birefringence elements 11a is incident on the third birefringence elements 12a, and light transmitted through the second birefringence elements 11b is incident on the fourth birefringence elements 12b. If light incident on the first polarization grating screen 11 has a polarization of 90°, the first and fourth birefringence elements 11a and 12b rotate incident light by +45°, and the second and third birefringence elements 11b and 12a rotate incident light by −45°, light transmitted through the first birefringence elements 11a is rotated by +45° to have a polarization of 135°, and light transmitted through the second birefringence elements 11b is rotated by −45° to have a polarization of 45°. Then, the light transmitted through the first birefringence elements 11a and incident on the third birefringence elements 12a is rotated by −45° to have a polarization of 90°. Also, the light transmitted through the second birefringence elements 11b and incident on the fourth birefringence elements 12b is rotated by +45° to have a polarization of 90°. That is, the polarization of light incident on the first polarization grating screen 11 and the polarization of light emitted from the second polarization grating screen 12 are the same. Accordingly, if polarization plates which transmit light with the same polarization are respectively disposed on a light incidence surface of the first polarization grating screen 11 and a light exit surface of the second polarization grating screen 12, the entire screen of the display device is displayed, thereby realizing a 2D image.

FIG. 5C is a sectional view of a stereoscopic display configured to obtain a 2D image. Referring to FIG. 5C, the stereoscopic display includes a display device 20 producing a predetermined image, a first polarization plate 23 transmitting only light with a predetermined polarization, the aforesaid first and second polarization grating screen 11 and 12, and a second polarization plate 24 facing the second polarization grating screen 12 and transmitting only light with a predetermined polarization among light transmitted through the second polarization grating screen 12. The first polarization plate 23, the first and second polarization grating screens 11 and 12, and the second polarization plate 24 constitute a parallax barrier unit that transmits all incident light in a 2D mode and forms a barrier in a 3D mode to separate images for a left eye and a right eye. In the 2D mode, as shown in FIG. 5B, the first and second polarization grating screens 11 and 12 overlap each other such that the first and second birefringence elements 11a and 11b of the first polarization grating screen 11 coincide with the corresponding third and fourth birefringence elements 12a and 12b of the second polarization grating screen 12.

In this structure, light produced by the display device 20 is first incident on the first polarization plate 23. The first polarization plate 23 may transmit only light with a polarization of 90° among light incident from the display device 20. After passing through the first polarization plate 23, part of the light continuously passes through the first birefringence elements 11a and the third birefringence elements 12a, and the remaining part of the light continuously passes through the second birefringence elements 11b and the fourth birefringence elements 12b. As described above, all light emitted from the second polarization grating screen 12 has a polarization of 90°. Accordingly, when the second polarization plate 24, like the first polarization plate 23, transmits only light with a polarization of 90°, the image provided from the display device 20 is transmitted to a viewer as it is. The display device 20 displays a general 2D image and the viewer can see the 2D image.

Although, in the present embodiment, the first and fourth birefringence elements 11a and 12b rotate incident light by +45° and the second and third birefringence elements 11b and 12a rotate incident light by −45°, the birefringence elements may rotate incident light at different angles. For example, the first and third birefringence elements 11a and 12a may rotate incident light by −45° and the second and fourth birefringence elements 11b and 12b may rotate incident light by +45°. Alternatively, the first and third birefringence elements 11a and 12a may rotate incident light by +45° and the second and fourth birefringence elements 11b and 12b may rotate incident light by −45°. In this case, if incident light with a polarization of 90° continuously passes through the first and third birefringence elements 11a and 12a, the transmitted light has a polarization of 180°. If incident light with a polarization of 90° continuously passes through the second and fourth birefringence elements 11b and 12b, the transmitted light has a polarization of 0°. Accordingly, if the first polarization plate 23 transmits only light with a polarization of 90°, the second polarization plate 24 should be able to transmit light with a polarization of 0° or 180°, perpendicular to the polarization of the first polarization plate 23.

Meanwhile, the display device 20 may be any kind of display, for example, a PDP. In this case, as shown in FIG. 5C, the parallax barrier unit consisting of the first polarization plate 23, the first and second polarization grating screens 11 and 12, and the second polarization plate 24 is interposed between the display device 20 and the viewer.

The display device 20 may be an LCD instead of a PDP. As is well known, an LCD includes a backlight unit 25 emitting light, a rear polarization plate 26 transmitting only light with a predetermined polarization among light emitted by the backlight unit 25, an LCD panel 27 polarizing incident light for each pixel and providing an image, and a front polarization plate 28 transmitting only light with a predetermined polarization among light transmitted through the LCD panel 27. Since the LCD includes the rear and front polarization plates 28 and 27, the front polarization plate 28 of the LCD may be used as the first polarization plate of the parallax barrier unit when the parallax barrier unit is interposed between the viewer and the LCD. In the meantime, as shown in FIG. 5D, the parallax barrier unit may be interposed between the backlight unit 25 and the LCD panel 27 of the LCD. In this case, the rear polarization plate of the LCD may be used as the second polarization plate of the parallax barrier unit.

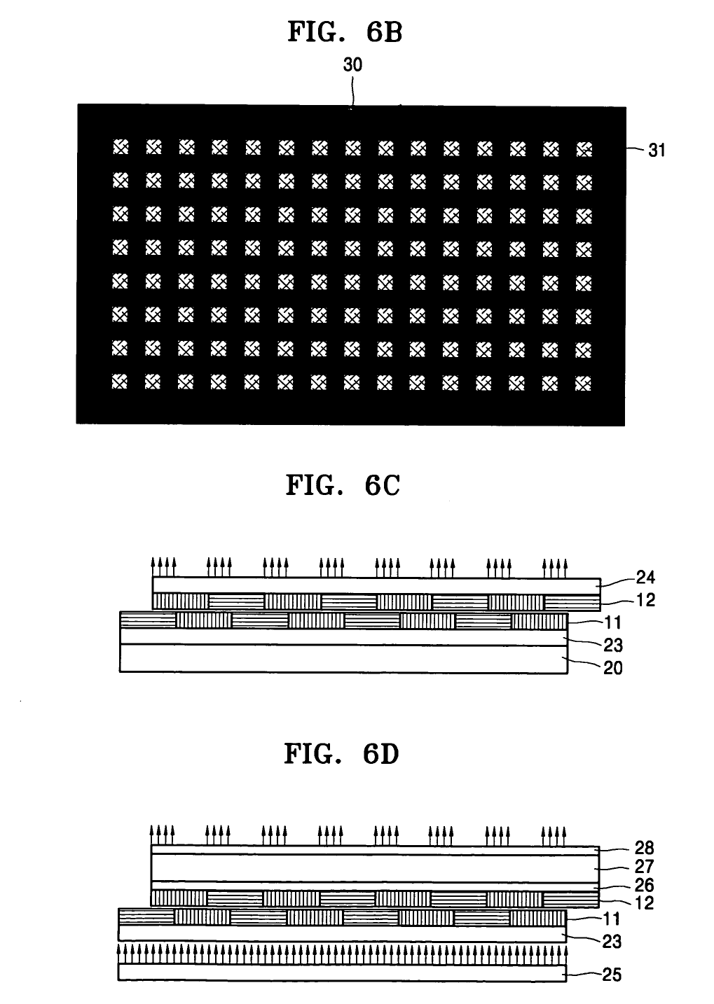

FIGS. 6A through 6D are schematic views for explaining a method of forming a 3D image in a stereoscopic display according to an embodiment of the present invention.

To realize a 3D image, the first polarization grating screen 11 and the second polarization grating screen 12 of the parallax barrier unit are relatively displaced by a predetermined distance in a diagonal direction. Either the first polarization grating screen 11, or the second polarization grating screen 12, or both can be moved. A maximum horizontal displacement of the first polarization grating screen 11 relative to the second polarization grating screen 12 is equal to the width of one pixel of the display device. That is, a horizontal displacement of the first polarization grating screen 11 relative to the second polarization grating screen 12 is not greater than the width of one pixel of the display device. Also, the first polarization grating screen 11 and the second polarization grating screen 12 are displaced such that the third line L3 of the first polarization grating screen 11 and the first line L1′ of the second polarization grating screen 12 partially overlap each other.

Then, as shown in FIG. 6A, the first and second birefringence elements 11a and 11b of the first polarization grating screen 11 are misaligned with the third and fourth birefringence elements 12a and 12b of the second polarization grating screen 12. Accordingly, part of the light transmitted through the first birefringence elements 11a is transmitted through the third birefringence elements 12a, and the remaining part of the light transmitted through the first birefringence elements 11a is transmitted through the fourth birefringence elements 12b. Part of the light transmitted through the second birefringence elements 11b is transmitted through the third birefringence elements 12a, and the remaining part of the light transmitted through the second birefringence elements 11b is transmitted through the fourth birefringence elements 12b. For example, if the first and fourth birefringence elements 11a and 12b rotate incident light by +45° and the second and third birefringence elements 11b and 12a rotate incident light by −45°, the stereoscopic display operates as follows.

First, light emitted from the display device 20 is transmitted through the first polarization plate 23 to have a polarization of 90°. Thereafter, part of the light transmitted through the first polarization plate 23 is transmitted through the first birefringence elements 11a to have a polarization of 135°, and the remaining light transmitted through the first polarization plate 23 is transmitted through the second birefringence elements 11b to have a polarization of 45°. Part of the light transmitted through the first birefringence elements 11a is transmitted through the third birefringence elements 12a to have a polarization of 90°, and the remaining light transmitted through the first birefringence elements 11a is transmitted through the fourth birefringence elements 12b to have a polarization of 180°. Also, part of the light transmitted through the second birefringence elements 11b is transmitted through the third birefringence elements 12a to have a polarization of 0°, and the remaining light transmitted through the second birefringence elements 11b is transmitted through the fourth birefringence elements 12b to have a polarization of 90°. Since the second polarization plate 24 transmits only light with a polarization of 90°, only the light continuously transmitted through the first birefringence elements 11a and the third birefringence elements 12a and the light continuously transmitted through the second birefringence elements 11b and the fourth birefringence elements 12b can be transmitted through the second polarization plate 24, and the other light is blocked.

Referring to FIG. 6A, in the first and second polarization grating screens 11 and 12, regions where the first birefringence elements 11a and the third birefringence elements 12a overlap each other and regions where the second birefringence elements 11b and the fourth birefringence elements 12b overlap each other are generated at predetermined intervals horizontally and vertically. As a result, as shown in FIG. 6B, apertures 31 transmitting light are regularly formed in two dimensions in a barrier 30 blocking light. That is, a parallax barrier that transmits light in the same manner as the parallax barrier for providing complete parallax shown in FIG. 3C is generated. In the present embodiment, the apertures 31 are formed for every 2×2 block of pixels. The size of each of the apertures 31 may be equal to or slightly smaller than the size of one pixel. Since the stereoscopic display according to the present embodiment provides a 3D image with complete parallax, even a viewer who lies on his side can see the 3D image.

As described above, the display device 20 may be a PDP or an LCD. Referring to FIG. 6C, similar to FIG. 5C, when the display device 20 is a PDP or an LCD, a parallax barrier unit consisting of the first polarization plate 23, the first and second polarization grating screens 11 and 12, and the second polarization plate 24 is interposed between the display device 20 and the viewer. Referring to FIG. 6D, similar to FIG. 5D, when the display device 20 is an LCD, a parallax barrier unit for generating a parallax barrier can be interposed between the backlight unit 25 of the LCD and the LCD panel 27. As described above, the rear polarization plate 26 of the LCD may be used as the second polarization plate of the parallax barrier unit. As shown in FIGS. 6C and 6D, the first and second polarization grating screens 11 and 12 are shifted and misaligned by a predetermined distance to provide a 3D image.

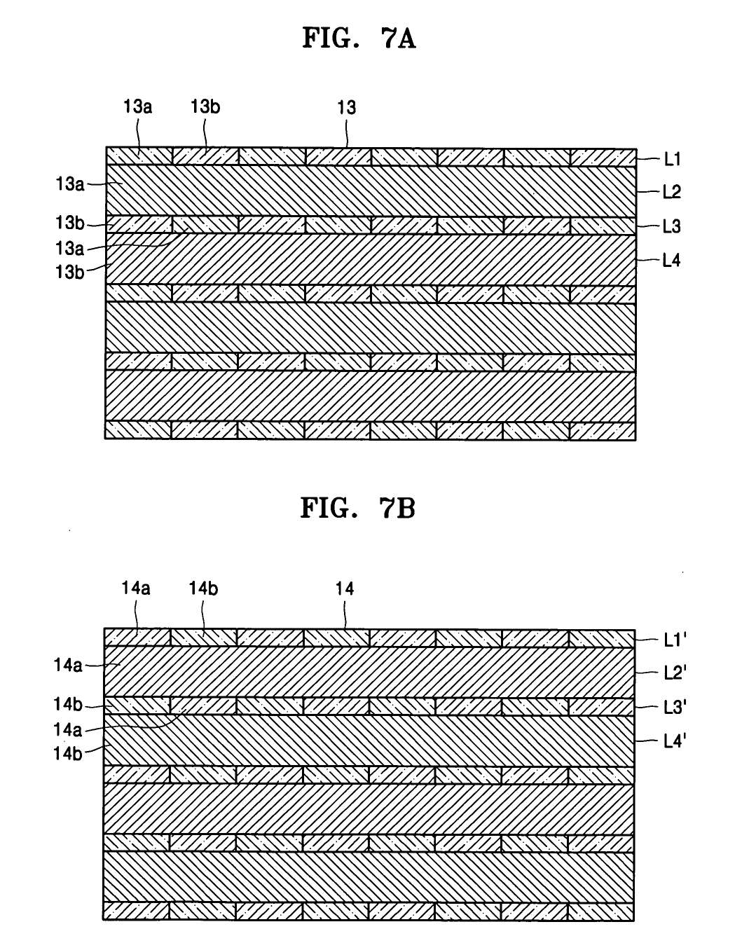

When the first and second polarization grating screens 11 and 12 illustrated in FIGS. 4A and 4B are used, an aperture is formed for every 2×2 block of pixels. Accordingly, a viewing zone in which a 3D image can be seen is relatively narrow. FIGS. 7A and 7B illustrate a first polarization grating screen 13 and a second polarization grating screen 14 of a 2D/3D switchable stereoscopic display according to another exemplary embodiment of the present invention. Referring to FIGS. 7A and 7B, an aperture is formed for every 4×4 block of pixels to increase a viewing zone in which a 3D image can be seen. The structures of the first and second polarization grating screens 13 and 14 illustrated in FIGS. 7A and 7B are identical to the structures of the first and second polarization grating screens 11 and 12 illustrated in FIGS. 4A and 4B except for the sizes of birefringence elements.

That is, the first polarization grating screen 13 is similar to the first polarization grating screen 11 of FIG. 4A in that the first polarization grating screen 13 includes first through fourth lines L1 through L4 formed in a repeating pattern, in which the first line L1 includes first birefringence elements 13a that change the polarization direction of incident light into one direction and second birefringence elements 13b that alternate with the first birefringence elements 13a and change the polarization direction of incident light to another direction, the second line L2 includes only the first birefringence elements 13a, the third line L3 includes the second birefringence elements 13b and the first birefringence elements 13a alternating with each other, and the first line L4 includes only the second birefringence elements 13b. Also, the second polarization grating screen 14 illustrated in FIG. 7B is similar to the second polarization grating screen 13 illustrated in FIG. 4B in that the second polarization grating screen 14 includes first through fourth lines L1′ through L4′ formed in a repeating pattern, in which the first line L1′ includes third birefringence elements 14a that change the polarization direction of incident light to one direction and fourth birefringence elements 14b that alternate with the third birefringence elements 14a and change the polarization direction of incident light to another direction, the second line L2′ includes only the third birefringence elements 14a, the third line L3′ includes the fourth birefringence elements 14b and the third birefringence elements 14a alternating with each other, and the fourth line L4′ includes only the fourth birefringence elements 14b.

The width of the first and second birefringence elements 13a and 13b of the first polarization grating screen 13 is equal to the width of four pixels of the display device. The sum of the heights of the first and second lines L1 and L2 of the first polarization grating screen 13 and the sum of the heights of the third and fourth lines L3 and L4 of the first polarization grating screen 13 are each equal to the width of four pixels of the display device. The heights of the first and third lines L1 and L3 are each approximately equal to the height of one pixel of the display device. The heights of the second and fourth lines L2 and L4 are each approximately equal to the height of three pixels of the display device. Since the pattern of the second polarization grating screen 14 coincides with the pattern of the first polarization grating screen 13, the sizes of the birefringence elements of the second polarization grating screen 14 illustrated in FIG. 7B can be equal to the sizes of the corresponding birefringence elements of the first polarization gratings screen 13.

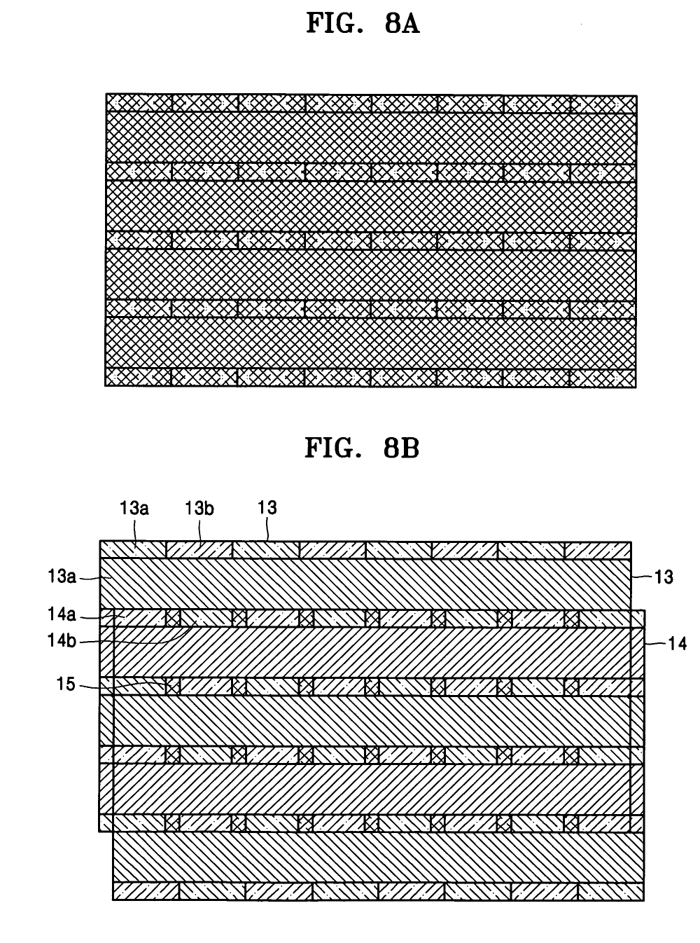

In this structure, when the first and second polarization grating screens 13 and 14 overlap each other as shown in FIG. 8A, a 2D image can be provided. When the first polarization grating screen 13 and the second polarization grating screen 14 are relatively displaced in a diagonal direction as shown in FIG. 8B, a plurality of apertures 15 transmitting light are regularly arranged in two dimensions to provide a 3D image with complete parallax and create a wider viewing zone. A maximum horizontal displacement of the first polarization grating screen 13 relative to the second polarization grating screen 14 is equal to the width of one pixel of the display device. A maximum vertical displacement of the first polarization grating screen 13 relative to the second polarization grating screen 14 is equal to the width of one pixel of the display device. Also, a vertical distance between the first polarization grating screen 13 and the second polarization grating screen 14 is formed such that the third line L3 of the first polarization screen 13 and the first line L1′ of the second polarization screen 14 overlap each other.

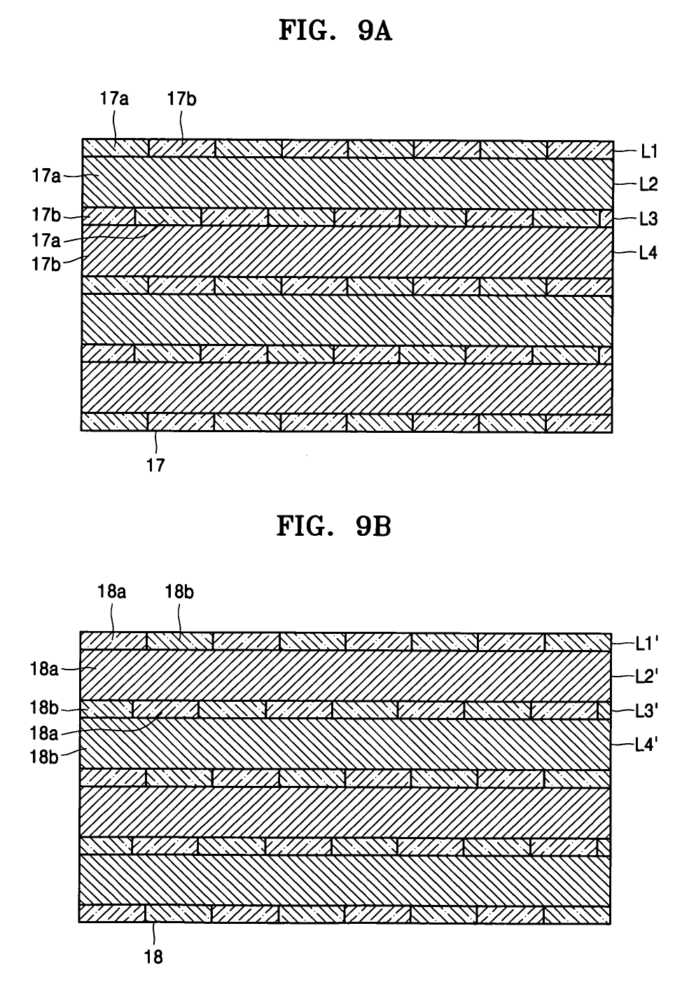

FIGS. 9A and 9B illustrate first and second polarization grating screens 17 and 18 of a 2D/3D switchable stereoscopic display according to still another exemplary embodiment of the present invention. The first and second polarization grating screens illustrated in FIGS. 4A and 4B and FIGS. 7A and 7B should be moved in a diagonal direction. Accordingly, the mechanism of moving the polarization grating screens to switch between a 2D mode and a 3D mode is complex. The first and second polarization grating screens illustrated in FIGS. 9A and 9B are moved only in a vertical direction to switch between a 2D mode and a 3D mode.

Referring to FIG. 9A, the first polarization grating screen 17 has a similar structure as the first polarization grating screen 13 illustrated in FIG. 7A except that a third line L3 is shifted horizontally from a first line L1. That is, the first polarization grating screen 17 illustrated in FIG. 9A includes first through fourth lines L1 through L4 formed in a repeating pattern. The first line L1 includes first birefringence elements 17a that change the polarization direction of incident light to one direction and second birefringence elements 17b that alternate with the first birefringence elements 17a and change the polarization direction of incident light to another direction, the second line L2 includes only the first birefringence elements, the third line L3 includes the second birefringence elements 17b and the first birefringence elements 17a alternating with each other, and the fourth line L4 includes only the second birefringence elements 17b. The third line L3 is shifted horizontally from the first line L1. The distance the third line L3 is shifted from the first line L1 may be less than or equal to the width of one pixel of the display device.

The second polarization grating screen 18 illustrated in FIG. 9B includes first through fourth lines L1′ through L4′ formed in a repeating pattern. The first line L1′ includes first third birefringence elements 18a that change the polarization direction of incident light to one direction and fourth birefringence elements 18b that alternate with the third birefringence elements 18a and change the polarization direction of incident light to another direction, the second line L2′ includes only the third birefringence elements 18a, the third line L3′ includes the fourth birefringence elements 18b and the third birefringence elements 18a alternating with each other, and the fourth line L4′ includes only the fourth birefringence elements 18b. The third line L3′ is shifted horizontally from the first line L1′. The distance the third line L3′ is shifted from the first line L1 may be less than or equal to the width of one pixel of the display device.

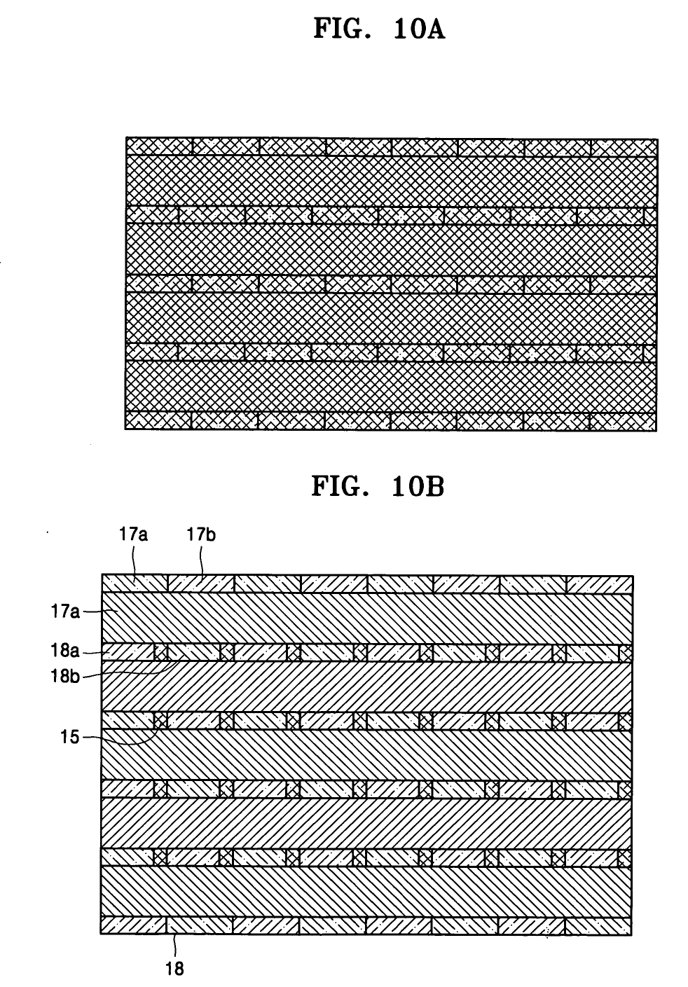

In this structure, when the first and second polarization grating screens 17 and 18 are aligned with each other as shown in FIG. 10A, a 2D image can be provided. When the first polarization grating screen 17 and the second polarization grating screen 18 are relatively displaced in a vertical direction as shown in FIG. 10B such that the third line L3 of the first polarization grating screen 17 coincides with the first line L1′ of the second polarization grating screen 18, a plurality of apertures 15 transmitting light are regularly formed in two dimensions. Accordingly, a 3D image with complete parallax can be provided and a wider viewing zone can be created.

As described above, since the 2D/3D switchable stereoscopic display according to the present invention uses two polarization grating screens, the display can be smoothly switched between a 2D mode and a 3D mode. Since apertures are formed every four or sixteen pixels in a 3D mode, a viewing zone in which a 3D image can be seen is wide. Moreover, since the 2D/3D switchable stereoscopic display can generate vertical parallax and horizontal parallax simultaneously, a stereoscopic image with complete parallax can be provided. Accordingly, a user can see a 3D image even while lying on his side.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A 2D/3D switchable stereoscopic display comprising:
a display device which displays an image; and
a parallax barrier unit comprising: a first polarization grating screen and a second polarization screen;
wherein the parallax barrier unit has a 2D mode and a 3D mode, and in the 2D mode, all light from the display device is transmitted through the parallax barrier unit, and in the 3D mode, the parallax barrier unit forms a barrier and a plurality of apertures which are arranged at predetermined intervals in two dimensions, such that light is only transmitted through the apertures and a 3D image with horizontal parallax and vertical parallax is provided.

2. The 2D/3D switchable stereoscopic display of claim 1, wherein the parallax barrier unit further comprises:
a first polarization plate which transmits only light having a predetermined polarization direction; and
a second polarization plate, facing the first polarization plate, which transmits only light having a predetermined polarization direction;
wherein the first polarization grating screen has groups of first, second, third, and fourth lines formed in a repeating pattern, wherein
the first line includes first birefringence elements that change the polarization direction of incident light to a first direction and second birefringence elements that alternate with the first birefringence elements and change the polarization direction to a second direction,
the second line includes only the first birefringence elements,
the third line includes the second birefringence elements and the first birefringence element alternating with each other, and
the fourth line includes only the second birefringence elements; and
wherein the second polarization grating screen has groups of first, second, third, and fourth lines formed in a repeating pattern, wherein
the first line includes third birefringence elements that change the polarization direction of incident light to the second direction and fourth birefringence elements that alternate with the third birefringence elements and change the polarization direction of incident light to the first direction,
the second line includes only the third birefringence elements,
the third line includes the fourth birefringence elements and the third birefringence elements alternating with each other, and
the fourth line includes only the fourth birefringence elements; and
wherein the first polarization grating screen and the second polarization grating screen are disposed between the first polarization plate and the second polarization plate.

3. The 2D/3D switchable stereoscopic display of claim 2, further comprising a displacement means for moving, at least one of the first polarization grating screen and the second polarization grating screen such that a 2D image or a 3D image is selectively displayed according to the relative positions of the first polarization grating screen and the second polarization grating screen.

4. The 2D/3D switchable stereoscopic display of claim 3, wherein a width of each of the first through fourth birefringence elements is equal to a width of two pixels of the display device, and a sum of the heights of the first and second lines and a sum of the heights of the third and fourth lines of each of the first and second polarization grating screens are each equal to a height of two pixels of the display device.

5. The 2D/3D switchable stereoscopic display of claim 4, wherein the height of each of the first line and the third line of each of the first and second polarization grating screens is not greater than the height of one pixel of the display device.

6. The 2D/3D switchable stereoscopic display of claim 3, wherein a width of each of the first through fourth birefringence elements is equal to a width of four pixels of the display device, and a sum of the heights of the first and second lines of the first polarization grating screen and a sum of the heights of the third and fourth lines of the second polarization grating screen are each equal to a height of four pixels of the display device.

7. The 2D/3D switchable stereoscopic display of claim 6, wherein the height of each of the first line and the third line of each of the first and second polarization grating screens is not greater than the height of one pixel of the display device.

8. The 2D/3D switchable stereoscopic display of claim 2, further comprising:
a displacement means for moving at least one of the first polarization grating screen and the second polarization grating screen in a diagonal direction to form a barrier which blocks light and has a plurality of apertures which are regularly arranged in two dimensions and transmit light.

9. The 2D/3D switchable stereoscopic display of claim 8, wherein a horizontal displacement of the first polarization grating screen relative to the second polarization grating screen is not greater than a width of one pixel of the display device, and the first polarization grating screen and the second polarization grating screen are vertically displaced such that the third line of the first polarization grating screen and the first line of the second polarization grating screen overlap each other.

10. The 2D/3D switchable stereoscopic display of claim 2, wherein the third line of the first polarization grating screen is shifted horizontally from the first line of the first polarization grating screen by a maximum distance corresponding to a width of one pixel of the display device, and the third line of the second polarization grating screen is shifted horizontally from the first line of the second polarization grating screen by a maximum distance corresponding to a width of one pixel of the display device.

11. The 2D/3D switchable stereoscopic display of claim 10, further comprising:
a displacement means for vertically displacing at least one of the first polarization grating screen and the second polarization grating screen to form a barrier which blocks light and has a plurality of apertures which are regularly arranged in two dimensions and transmit light.

12. The 2D/3D switchable stereoscopic display of claim 11, wherein the displacement means vertically displaces at least one of the first polarization grating screen and the second polarization grating screen such that the third line of the first polarization grating screen and the first line of the second polarization grating screen overlap each other.

13. The 2D/3D switchable stereoscopic display of claim 2, wherein
the first and fourth birefringence elements are rotators which rotate incident light by +45° and the second and third birefringence elements are rotators which rotate incident light by −45, or
the first and fourth birefringence elements are rotators which rotate incident light by −45° and the second and third birefringence elements are rotators which rotate incident light by +450.

14. The 2D/3D switchable stereoscopic display of claim 13, wherein the first polarization plate and the second polarization plate transmit light with the same predetermined polarization direction.

15. The 2D/3D switchable stereoscopic display of claim 2, wherein
the first and third birefringence elements are rotators which rotate incident light by +45° and the second and fourth birefringence elements are rotators which rotate incident light by −45′, or
the first and third birefringence elements are rotators which rotate incident light by −45° and the second and fourth birefringence elements are rotators which rotate incident light by +45°.

16. The 2D/3D switchable stereoscopic display of claim 15, wherein the first polarization plate and the second polarization plate transmit light with perpendicular predetermined polarization directions.

17. The 2D/3D switchable stereoscopic display of claim 2, wherein
the first and fourth birefringence elements are retarders which phase-delay incident light by +λ/4 and the second and third birefringence elements are retarders which phase-delay incident light by −λ/4, or
the first and fourth birefringence elements are retarders which phase-delay incident light by −λ/4 and the second and third birefringence elements are retarders which phase-delay incident light by +λ/4; and
λ is the wavelength of incident light.

18. The 2D/3D switchable stereoscopic display of claim 17, wherein the first polarization plate and the second polarization plate transmit light with the same predetermined polarization direction.

19. The 2D/3D switchable stereoscopic display of claim 2, wherein the first and third birefringence elements are retarders which phase-delay incident light by +λ/4 and the second and fourth birefringence elements are retarders which phase-delay incident light by −λ/4, or the first and third birefringence elements are retarders which phase-delay incident light by −λ/4 and the second and fourth birefringence elements are retarders which phase-delay incident light by +λ/4.

20. The 2D/3D switchable stereoscopic display of claim 19, wherein the first polarization plate and the second polarization plate transmit light with perpendicular predetermined polarization directions.

21. The 2D/3D switchable stereoscopic display of claim 2, wherein the display device comprises:
a backlight unit which emits light;
a rear polarization plate which transmits only light having a predetermined polarization;
a liquid crystal display panel which polarizes incident light for each pixel and provides an image; and
a front polarization plate which transmits only light having a predetermined polarization,
wherein the parallax barrier unit is disposed between the liquid crystal display panel and a viewer, and the front polarization plate of the display device is the first polarization plate of the parallax barrier unit.

22. The 2D/3D switchable stereoscopic display of claim 2, wherein the display device comprises:
a backlight unit which emits light;
a rear polarization plate which transmits only light having a predetermined polarization;
a liquid crystal display panel which polarizes incident light for each pixel and provides an image; and
a front polarization plate which transmits only light having a predetermined polarization,
wherein the parallax barrier unit is disposed between the backlight unit and the liquid crystal display panel, and the rear polarization plate of the display device is the second polarization plate of the parallax barrier unit.

23. An image display comprising:
a display device which displays an image; and
a parallax barrier unit, comprising a first polarization grating screen and a second polarization grating screen, facing the first polarization grating screen,
wherein the parallax barrier unit forms a barrier and a plurality of apertures which are arranged at predetermined intervals in two dimensions, thereby transmitting light through only the apertures and thus providing a 3D image with horizontal parallax and vertical parallax.

24. The image display of claim 23, wherein the parallax barrier unit comprises:
a first polarization plate which transmits only light having a predetermined polarization direction; and
a second polarization plate, facing the first polarization plate, which transmits only light having a predetermined polarization direction;
wherein the first polarization grating screen has groups of first, second, third, and fourth lines formed in a repeating pattern, wherein
the first line includes first birefringence elements that change the polarization direction of incident light to a first direction and second birefringence elements that alternate with the first birefringence elements and change the polarization direction to a second direction,
the second line includes only the first birefringence elements,
the third line includes the second birefringence elements and the first birefringence element alternating with each other, and
the fourth line includes only the second birefringence elements; and
wherein the second polarization grating screen has first, second, third, and fourth lines formed in a repeated pattern, wherein
the first line includes third birefringence elements that change the polarization direction of incident light to the second direction and fourth birefringence elements that alternate with the third birefringence elements and change the polarization direction of incident light to the first direction,
the second line includes only the third birefringence elements,
the third line includes the fourth birefringence elements and the third birefringence elements alternating with each other, and
the fourth line includes only the fourth birefringence elements;
wherein the first polarization grating screen and the second polarization grating screen are disposed between the first polarization plate and the second polarization plate.

25. The image display of claim 24, wherein a difference between a polarization change direction using the first birefringence elements and a polarization change direction using the second birefringence elements and a difference between a polarization change direction using the third birefringence elements and a polarization change direction using the fourth birefringence elements, respectively, are 90°.

26. The image display of claim 24, wherein the third line of the first polarization grating screen is shifted horizontally from the first line of the first polarization grating screen by a maximum distance corresponding to a width of one pixel of the display device, and the third line of the second polarization grating screen is shifted horizontally from the first line of the second polarization grating screen by a maximum distance corresponding to a width of one pixel of the display device.

27. A method of switching two-dimensional (2D) and three-dimensional (3D) images, the method comprising:
providing a parallax barrier unit comprising a first polarization grating screen and a second polarization grating screen,
wherein the first polarization grating screen has groups of first, second, third, and fourth lines formed in a repeating pattern, wherein
the first line includes first birefringence elements that change the polarization direction of incident light to a first direction and second birefringence elements that alternate with the first birefringence elements and change the polarization direction to a second direction,
the second line includes only the first birefringence elements,
the third line includes the second birefringence elements and the first birefringence element alternating with each other, and
the fourth line includes only the second birefringence elements; and
wherein the second polarization grating screen has groups of first, second, third, and fourth lines formed in a repeating pattern, wherein
the first line includes third birefringence elements that change the polarization direction of incident light to the second direction and fourth birefringence elements that alternate with the third birefringence elements and change the polarization direction of incident light to the first direction,
the second line includes only the third birefringence elements,
the third line includes the fourth birefringence elements and the third birefringence elements alternating with each other, and
the fourth line includes only the fourth birefringence elements; and
moving at least one of the first and second polarization grating screen with respect to the other polarization grating screen.
